(19) United States
(12) Patent Application Publication
(10) Pub. No.: US 2008/0282615 A1
(43) Pub. Date: Nov. 20, 2008

(54) WINDOW OPENING PROTECTOR

(76) Inventors: Craig Myhre, Seattle, WA (US); David W. Johnston, Seattle, WA (US)

Correspondence Address: BLACK LOWE & GRAHAM, PLLC, 701 FIFTH AVENUE, SUITE 4800, SEATTLE, WA, 98104, US

(21) Appl. No.: 12/106,131

(22) Filed: Apr. 18, 2008

Related U.S. Application Data
(60) Provisional application No. 60/913,254, filed on Apr. 20, 2007.

(51) Int. Cl. E06B 3/30

(52) U.S. Cl. 49/460; 49/506

(57) ABSTRACT

The embodiment of this invention relates generally to a method and apparatus for covering a window opening in the absence of a window, more particularly to a lightweight, cost effective and temporary protective cover for a window opening in the absence of the window pane for protecting the interior of a building from external elements.

### PRIORITY CLAIM

This application claims priority from earlier filed U.S. Provisional Patent Application Ser. No. 60/913,254, filed Apr. 20, 2007. The foregoing application is hereby incorporated by reference in its entirety as if fully set forth herein.

### FIELD OF THE INVENTION

This invention relates generally to a method and apparatus for covering a window opening, more particularly to a lightweight, cost effective and temporary protective cover for a window opening for protecting the interior of a building from external elements.

### BACKGROUND OF THE INVENTION

Window guards and window protectors are well known. They are generally made of a board that is removably mounted to a window to cover and protect the windowpane. Most such window guards or protectors are designed for the purpose of protecting a window from damage during a storm (e.g., U.S. Pat. No. 5,507,118; U.S. Pat. No. 5,335,452; U.S. Pat. No. 5,228,238), intruders (e.g., U.S. Pat. No. 4,972,639), and other harmful phenomena (e.g., U.S. Pat. No. 4,495,978; U.S. Pat. No. 3,485,954, directed to nuclear radiation). Most often, they are designed so as to not disrupt the normal operation of the window or the aesthetic appearance of the window while not in use, and are specifically designed to be on the exterior of the building to protect the window from externally occurring phenomena. Additionally, these examples are generally designed as permanent features of the building; either being permanently installed onto the window frame or building or attaching to permanent fixtures that are secured on the exterior of the building. The window guards thereby are conveniently in place when a disruption occurs. Such systems are not specifically designed to protect the interior of the building in the temporary absence of the window.

Windows frequently need to be replaced on a construction site or when a windowpane becomes broken. Windows are also blown out due to natural disasters such as earthquakes, tornadoes, and hurricanes. A broken windowpane or the absence of a window in an occupied building causes a great deal of disruption to the occupants and creates a mess in the interior. A quick, temporary, and cost effective solution is often necessary. For example, in a residential dwelling, window replacement during a construction job creates a great deal of dust and debris in the interior, often necessitating a complete vacation of the dwelling. The temporary construction also exposes the interior of the house to weather and poses a risk to the security of the occupants. A common fix to the problem is to affix a tarp, plastic sheet, or drop-cloth over the opening until the window is replaced. The temporary makeshift covering is often held in place by staples, masking tape, or nails, often damaging the interior walls. This solution is unsatisfactory for many reasons. For example, plastic sheets often become wind-blown, letting in weather, dust and debris. Furthermore, plastic sheeting does not secure the worksite, making occupants vulnerable during the construction phase. Intruders can easily break in, and pets and children can easily slip out undetected.

Therefore, a need exists in the market for an apparatus and a method to protect a window opening in the absence of a window for the purpose of protecting the interior during repair, for example, during a construction project, where a quick, cost effective and temporary solution is required.

These and other embodiments of the invention will be described in further detail below.

### BRIEF DESCRIPTION OF THE DRAWINGS

Preferred and alternative embodiments of the present invention are described in detail below with reference to the following drawings:

FIG. 1A and inset shows front view and magnified view of an embodiment of a window opening protector according to the present invention;

FIG. 1B shows a front view of an embodiment of a window opening protector with an adjustable perimeter frame element;

FIG. 2 shows side views of an embodiment of a window opening protector according to the present invention;

FIGS. 3A and 3B show a side and front view with a vacuum source attachment, and attachment points for the vacuum source. FIG. 3B further illustrates a front view of the cover including additional reinforcing members.

FIG. 4 is a flowchart of one embodiment of the method of the invention in operation.

### DETAILED DESCRIPTION OF THE PREFERRED EMBODIMENT

One embodiment of the present invention is a device for adjustably providing protection of a window opening in the absence of a window. The purpose of this exemplary embodiment is to protect the interior of a building, for example, during a construction project, where a cost effective and temporary solution is required.

An embodiment of the present invention is a window opening protector mountable over a window opening, the window opening protector comprising: a cover element sized to fit over a window opening and an adjustable brace assembly.

In accordance with some embodiments of the invention, the cover element of the window opening protector can be made from pre-cut, or user-cut materials. Examples of materials for the cover element include, but are not limited to cardboard, plywood, or plastic, such as Lexan®. It is contemplated that a cover element may be translucent or opaque, dependent on the user application, and in a preferred embodiment is made of light weight material.

In accordance with some embodiments of the invention, the cover element of the window opening protector can be pre-cut to a standard window opening size. In an alternative embodiment, a cover element can be cut to size by the user using a window frame sizing template. Pre-cut cover elements correspond to commonly used standard sized windows, including, but not limited to: 24″×24″, 36″×36″, 48″×48″, 60″×60″, and 72″×72″. In an alternative embodiment, size templates based on industry standards, window manufacturer (e.g. Milgard®, Pella®), hinge placement (e.g., top/side/bottom), window opening type (e.g., opening in or out), and window classification (e.g., casement windows, picture windows, horizontal sliders, vertical sliders, sliding glass doors, and the like) can be used. The user can utilize a size template to accurately fit the height and width of the opening and to cut a cover element for use with the brace element of this invention.

In an exemplary embodiment, the cover element is cut to a size that fits within the frame of the window opening, such that the cover element can rest on the window sill or frame, and, more particularly, fit snugly against the window prior to the window removal. In this example, a more accurate measurement of the interior frame must be made and allowances made for the frame size and inset. In another exemplary embodiment, the cover element can cover the entire window opening. In operation, the cover element would contact the interior wall covering the entire opening, but not necessarily fit within the recess of the window opening. As can be appreciated, less exact measurement of the window frame itself can be made, and approximate standardized sizing is facilitated by this approach.

In accordance with some embodiments of the invention, the brace assembly can be adjustable in length. For example, the adjustable pole member, an integral element of the brace assembly, can be retractable, telescoping, or have removable sections. The use of extension rods, lightweight extendable and retractable poles, and/or telescoping extension rods or poles are well known for household tools such as vacuum cleaner attachments, and mop handles, and functional construction tools such as painting brush poles, as well as flag poles, sports equipment poles, and the like. Structural configurations and designs have been developed for the fulfillment of countless objectives and requirements wherein a plurality of pieces are fit one within the other, or alternatively connecting end to end, with various positioning and locking means to facilitate the expansion of the rods' length. While these devices fulfill their respective objectives and requirements, the present invention substantially departs from the concepts of the prior art, and in doing so, provides an apparatus primarily developed for the purpose of providing an adjustable brace for a window opening protector, positionable between a cover element and a frictionally engaged foot, to secure the cover element in the window opening.

In operation, the brace assembly, and in particular the adjustable pole member of the brace assembly, is extended by the user to a length approximately equal to the distance from the adjustable foot of the brace assembly to the cover element positioned against the window opening, such that the adjustable pole member and the engaging surface, for example a floor, are at a less than 90 degree angle to each other. Pressure is created on the cover element as the adjustable pole member is extended. Once the cover is securely and snugly in place, the length of the adjustable pole member is correct and the cover element is properly positioned over the window opening.

In accordance with other embodiments of the invention, the brace assembly can be coupled to a mounting element by a mechanism that enables the flat mounting element to adjustably rotate relative to the adjustable pole member. In a non-limiting example, the mechanism can be a ball and socket connection. The mounting element can assume a suitable position (e.g., approximately centrally located) relative to the cover element to press flatly and evenly against the cover element when the brace assembly is in place. The size and shape of the mounting plate is in accordance with the application, and can depend on the materials employed for the cover element.

In accordance with other embodiments of the invention, the brace assembly can be adjusted along its length to accommodate different angles in operation. A variety of lockable hinge mechanisms are known for poles and rods for providing selective pivotal motion, collapsibility, and for locking angular relationships between elements. In a nonlimiting example, the mechanism to adjust the angle can be lockable hinged mechanisms placed along the length of the pole, to secure abutting elements of the adjustable pole member in any desired angular relationships. In one non-limiting embodiment, the adjustable pole member can be adjusted at a lockable hinge along its length to bend around furniture, architectural features, and other obstacles in a typical occupied interior near the window opening wall. The hinge allows workers to affix the cover element over the window opening with the least amount of disruption to the interior fixtures, and provides a quick solution to what otherwise would be a time consuming moving job.

In accordance with still further embodiments of the invention, the brace assembly is attached at one end to an adjustable foot, for example, a swiveling rubber foot, to secure the brace to an engaging surface, for example a floor, at an angle to the window opening, via friction.

In accordance with yet another example of the invention, the brace assembly may include an adjustable pole member that is hollow. The hollow adjustable pole member can be attached to the cover element, such that a vacuum can be applied. In one embodiment, a cover element can be fitted against a newly installed window and a vacuum applied to pressure test the window for leaks. In an alternative embodiment, a vacuum source can be directly attached to the cover element at a connector element on the cover element. In operation, the user can attach an external vacuum source while the cover element is against the window or window opening and apply the vacuum. If the window leaks, or is otherwise improperly sealed, water can be pulled through the vacuum. It is contemplated that the vacuum system can also be applied generally to remove dust and debris at the worksite.

In accordance with still further embodiments of the invention, the cover can include additional reinforcing member that are either horizontal, vertical, or both. The reinforcement members can add further stability to the cover element, thus providing greater protection from the external elements and reinforcing light weight materials that cover window openings.

In accordance with still further embodiments of the invention, the cover element can be made from an adjustable frame element that sizably adjusts, and then is positioned over a flexible cover element material, the cover element conforming to the size of the frame and kept in place in the window opening by the frame.

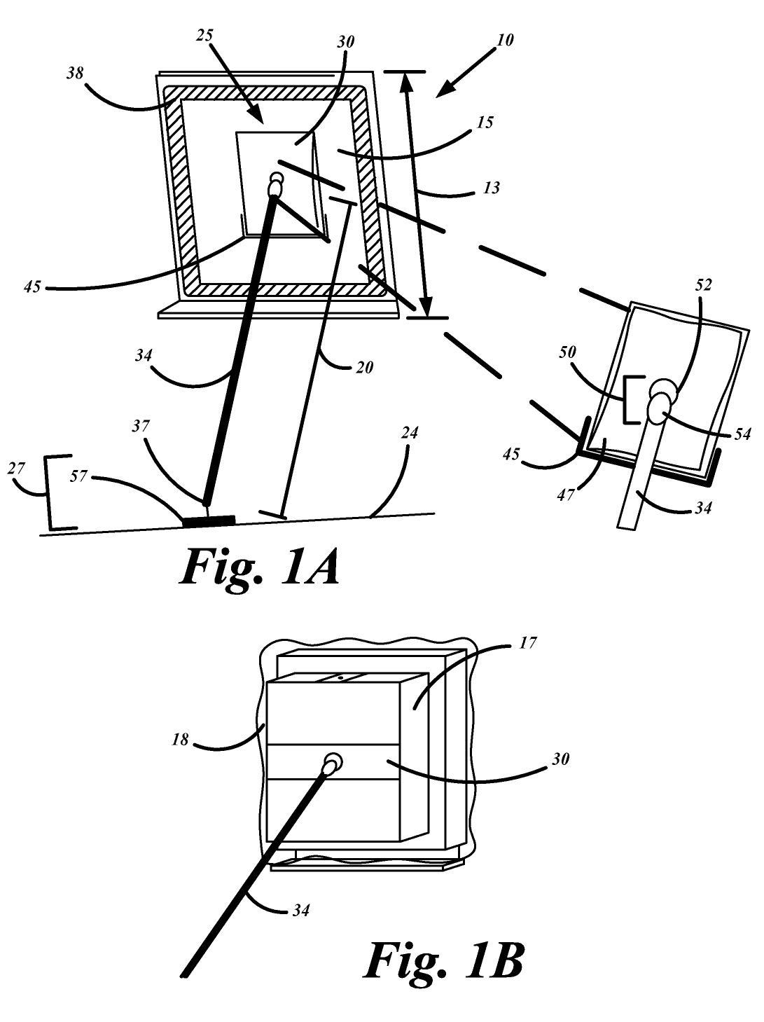

FIG. 1A illustrates a front view of an embodiment 10 of a device according to the present invention. The device is a window opening protector assembly 10 mountable over window opening 13, the window opening protector assembly 10 comprising: a cover element 15 sized to fit the window opening 13, and an adjustable brace assembly 20. The cover element 15 is sized to fit the window opening 13, and is made of materials suitable for the application. Preferably the cover element is made of a rigid material capable of light impacts, and is also lightweight. Other considerations for the use of the material include, for example, light weight materials (e.g. cardboard, Plexiglas, rigid foam) may be preferable for large scale windows; opaque or translucent materials may be more or less suitable for different rooms (e.g., ground floor living rooms, upstairs bedrooms); residential or commercial applications (e.g., residential bedrooms, commercial shop fronts) may necessitate the use of opaque, high gauge materials (e.g. plywood) where visibility as well as security may be a concern; the length of the project (e.g. one week to one month) may necessitate different concerns about how long an occupant may be without light, visibility, or access, or how sturdy and long-lasting the material should be; or weather concerns (e.g., tornado prone areas, wind-blown exposures, extreme heat, or extreme cold) may necessitate the use of materials which are higher gauge, hold up against water insult, insulate from cold, and/or reflect heat. Additionally, in some cases, security may be a key concern (e.g., commercial applications in urban areas). In this situation, a light weight, bullet proof Lexan® cover element may be utilized to withstand high impact.

It is contemplated that in a commercial application, for example, one in which a high volume of standard-sized windows are known (e.g. an apartment complex), the cover element 15 can be pre-cut from any material, as exemplified above, and supplied with a mounting bracket 45 already attached. In an alternative embodiment, gridded templates can also be provided, where standard width and height dimensional sizes for windows are printed as patterns that a user can follow to fabricate a cover element according to their need.

In accordance with further embodiments of the window opening protector assembly 11, in FIG. 1B the cover element can further comprise an adjustable perimeter frame element 17 that is sizably adjusted to fit the window opening 13. In operation, the frame element 17 defines the perimeter boundaries of the cover element, and the window opening 13 itself, is covered by a flexible material, such as high gauge plastic sheeting that is then pushed into the space by the perimeter frame element 17. The internal flexible material 18 conforms to the size of the perimeter frame element 17 and is thus kept in place in the window opening 13 by the perimeter frame element 17. In this exemplary embodiment the mounting plate 30 can be attached to opposing sides of the perimeter frame element 17 to engage an adjustable pole member 34, at one end of the of the brace assembly 20.

Turning back to FIG. 1A, in another embodiment, the cover element 15, can optionally have a detachably fitted bumper element 38, fitted around the perimeter of the cover element 15, to protect the window opening 13 from damage while in contact with the cover element 15. The bumper element 38, can be made of flexible materials such as, but not limited to rubber, foam, or polystyrene, which can both easily bend and conform to the cover element's shape and give when pressure is applied against them.

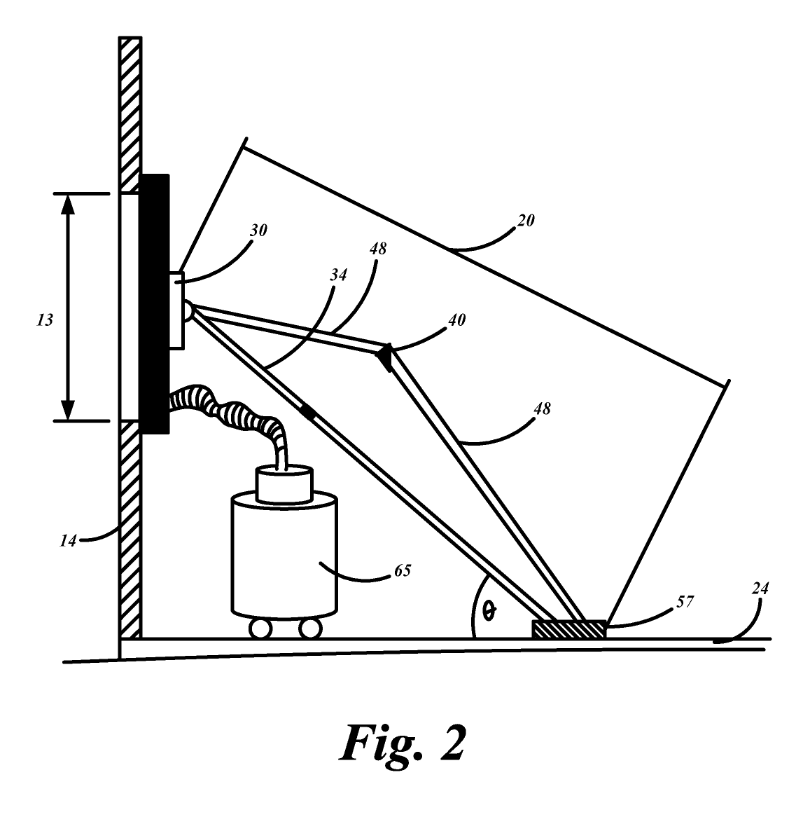

In FIG. 1A and the inset, the brace assembly 20 and exemplary coupling mechanism 50 is illustrated. The brace assembly 20 has two ends: a first end 25 proximal to the mounting plate 30 that has a flat surface. A second and distal end 37 is attached to a pivotally adjustable foot 57 to contact the engaging surface 24, for example a floor. In operation, as is illustrated in FIG. 1 and also in FIG. 2, the brace assembly further comprises a first element, an adjustable pole member 34. A first end 36 of the adjustable pole member 34 is detachably and rotatably coupled to the mounting plate 30. A second end 37 of the adjustable pole member 34 is attached to the adjustable foot element 57.

In operation, and as a first step, the mounting plate 30, can be fixed into position on the cover element 15, by fitting within a mounting bracket 45 on the cover element 15 prior to the coupling to the brace assembly 20. As a second step, the mounting plate 30 can be detachably and rotatably coupled to the adjustable pole member 34 by a coupling mechanism 50, such as, but not limited to a ball and socket mechanism. The receiving socket 52 on the coupling side 47 of the mounting plate 30 receives the ball 54 on a first end 25 of the adjustable pole member 20. In operation, the user places the cover element 15 over the window opening 13 and then attaches the adjustable pole member 34, pressing a second, flat surface 46 of the mounting plate 30 flatly against the cover element 15 and against the window opening 13.

In another exemplary embodiment, as a first step, the mounting plate 30 can be coupled to the adjustable pole member 34 by the coupling mechanism 50, as described above. In a second step, the user can place the cover element 15 over the window opening and in contact with the second, flat surface 46 of the mounting plate, and flatly press the brace assembly 20, now complete with mounting plate 30 and adjustable pole member 34, against the cover element 15 and against the window opening 13. Optionally, the cover element can have a mounting bracket 45 to receive the mounting plate 30 to stabilize the connection between the cover element 15 and the brace assembly 20.

The adjustable foot element 57 attached at the second end 37 of the adjustable pole member 34 frictionally engages the engaging surface 24, for example a floor, at an angle to the window opening 13. In one embodiment, the adjustable foot element has a flat bottom surface, with, for example, a rubber surface, the rubber preventing slipping of the adjustable foot element 57 while in operation. The adjustable foot element 57 is pivotably engaged in relation to the adjustable pole member 34. The pivotablity of the foot element 57 keeps the bottom surface of the foot flush with the engaging surface 24, for example a floor, when the foot element engages frictionally with said engaging surface 24 at an angle to the window opening.

Turning to FIG. 2, the brace assembly 20 can be fixed at an angle to the window opening 13 once the cover element is placed in the window opening 13 by extending the adjustable pole member 34 to an adjusted length. Once fully extended, the brace assembly both frictionally engages the engaging surface 24, for example a floor, at one end, and the cover element 15 in the window opening 13 at the other. In operation, the brace assembly 20, and in particular the adjustable pole member 34 is extended by the user to a length equal to the distance between the adjustable foot 57 and the cover element 15 when the brace assembly is pressed against the window opening 13. Generally, the distance is approximately the length of the hypotenuse, where a right triangle is formed between the wall with the window opening (opposite) and the engaging surface (adjacent) (e.g. a floor), where the length of the hypotenuse is dependent on the distance the adjustable foot element 57 is from the wall with the window opening 14 and the angle formed between the adjustable pole member 34 and engaging surface 24. Pressure is created on the cover element 15 as the adjustable pole member 34 is extended to the correct length. Once the cover element 15 is securely and snuggly in place, the length of the adjustable pole member 34 is correct and the cover element 15 is properly positioned over the window opening 13.

The adjustable pole member 34 may be retractable, telescoping, or include removable sections. In a preferred embodiment, the adjustable pole member 34 can include a plurality of telescoping tubular members (not shown): a first telescoping tubular member having side walls shaped to conformingly mate with a second telescoping tubular member; the second telescoping tubular member being telescopingly mated with said first telescoping tubular member, said second telescoping tubular member being sized and shaped to conformingly mate with said first telescoping tubular member. A holding mechanism, such as but not limited to, aligned bore holes, operate to fix the second telescoping tubular member within the first telescoping tubular member within a range of relative positions between said first and second telescoping tubular members. The length of the pair of telescoping tubular members, when telescoped, can be adjusted to a position within said range and held in such position. A lock mechanism (not shown), such a spring actuated detent, for locking said first telescoping tubular member to said second telescoping tubular member, fixes the length in any of said positions within said range. Pieces can be added and removed according the user's need, each tubular member fitting together as described.

In accordance with other embodiments of the invention, the brace assembly 20 can be adjusted along its length to accommodate different angles in operation. A variety of lockable hinge mechanisms are known for poles and rods for providing selective pivotal motion, collapsibility, and for locking angular relationships between elements. In a nonlimiting example, the mechanism to adjust the angle can be lockable hinged mechanisms 40 placed along the length of the pole, to secure abutting elements 48 of the adjustable pole member 34 in any desired angular relationships. In FIG. 2, for example, the adjustable pole member can be adjusted at the lockable hinge mechanism 40 along its length to bend around furniture, architectural features, and other obstacles in a typical occupied interior near the window opening wall 14. The lockable hinge mechanism 40 allows workers to affix the cover element 15 over the window opening 13 with the least amount of disruption to the interior fixtures, and provides a quick solution to what otherwise would be a time consuming moving job.

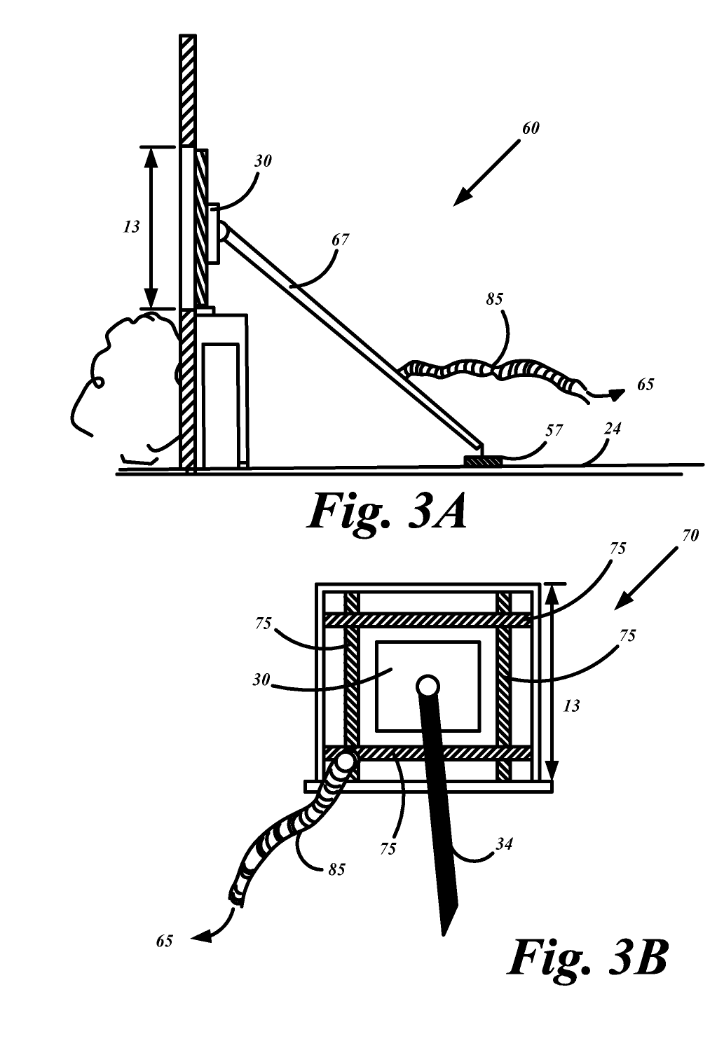

FIGS. 3A and 3B show an alternate embodiment 60 and 70 of the present invention. The exemplary embodiments include an attachment port for a vacuum source (at 65, also see FIG. 2), to be connected at a point either at a hollow adjustable pole member 67 (FIG. 3A) or to an attachment connection (not shown) on the cover element 15 (FIG. 3B). In FIG. 3A, The hollow adjustable pole member 67 further includes a connection port for the vacuum source (not shown). The hollow adjustable pole member 67 is attached to the cover element 15. When a vacuum is applied from the source 65 through the hollow adjustable pole member 67 to the cover 15, the vacuum can urge dust and other debris through the hollow adjustable pole member 67, and into a vacuum source 65 with a receptacle which can also include a HEPA filter. In another embodiment, a vacuum can be applied through the hollow adjustable pole member 67 when the cover element 15 is fitted against a newly replaced window to pressure test the window. Leaks can be detected if water is pulled through breaches in the seal around the frame and/or window panes.

FIG. 3B illustrates another embodiment 70 of the present invention. Here, the vacuum source 65 can be attached to a hose 85. The hose 85 is attached at a coupling mechanism (not shown) to the cover element 15, and the vacuum source 65, at the other. Also illustrated the cover 15 can additionally include reinforcing members 75, either horizontally, vertical, or both (as shown), for greater protection and for stabilizing lightweight materials.

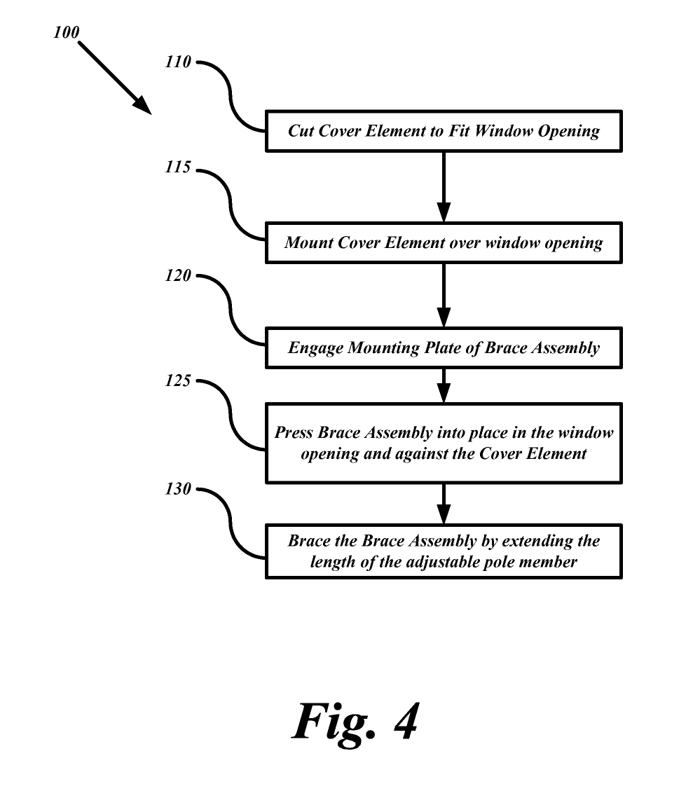

FIG. 4 is a flowchart of a method 100 of protecting a window opening as is illustrated in FIGS. 1-3. At a block 110, and as a first step a cover element 15 is cut to the size of a window opening 13 of a building. Next at a block 115, the cover element 15 is mounted over the window opening, in this case fitting within the window frame of the window opening. It is appreciated that this is by way of example, and that the invention does not require a window frame for operation. Next, at a block 120, a brace assembly, further comprising: an adjustable pole member 34, a rotatably and detachably coupled flat mounting plate 30, and an adjustable foot element 57, is arranged in relationship to the window frame opening 13. As discussed previously, the flat mounting element 30 can be first attached to the cover element 15 and then engaged via a coupling mechanism 50 with a first end 36 of the adjustable pole member 34. Alternatively, the flat mounting element 30 can be engaged with the adjustable pole member 34 as a first step, and then pushed against the cover element 15 as a second step. The order of the step is not critical, and either order of steps is fully embraced in the method 100 as described. The decision to do one before the other is dependent on the user and the application. In this example, at the block 120 the flat mounting plate 30 is engaged at a first end 36 of the brace assembly 20 and is then pressed at a block 125 against the cover element 30, mounted at the block 115 over the window opening 13 of a building. At a block 130, the cover element is braced against the window opening by adjusting the length of the adjustable pole member 34 of the brace assembly 20 to secure the cover element 15 in place.

While the preferred embodiment of the invention has been illustrated and described as noted above, many changes can be made without departing from the spirit and scope of the invention. For example, although the enclosed description primarily focuses on interior use, the method and device of the present invention can be used for external applications. Additionally, many different materials can be used for the invention, depending on the desired use of the invention, only a few of which have been mentioned. Different sizes and shapes of cover element can be used, and pre-cut or template cut cover elements are contemplated for regular practice. The brace assembly can employ different extension means and different locking means to fix the length of the adjustable pole member. A variety of pivotable joints can be used for the mounting plate attachment, and the pole can be hollow or solid, straight or articulated. Accordingly, the scope of the invention is not limited by the disclosure of the preferred embodiment.

The embodiments of the invention in which an exclusive property or privilege is claimed are defined as follows:

1. A window opening protector assembly mountable over a window opening, said window opening protector assembly comprising:
a cover element sized to fit a window opening; and
a brace assembly which comprises a adjustable pole member, a mounting plate, and an adjustable foot element, and wherein
a first end of the adjustable pole member is rotatably and detachably coupled to the mounting plate at a first coupling side, and the second side of the mounting plate is in detachable contact with the cover element; and
a second end of the adjustable pole member is attached to the adjustable foot element to frictionally engage a surface at an angle to the window opening.

2. The window opening protector assembly of claim 1, wherein the mounting plate is rotatably and detachably coupled to one end of the adjustable pole member by a ball and socket fitting.

3. The window opening protector assembly of claim 1, wherein the cover element further comprises two sides wherein a mounting bracket on a first side of the cover element is positioned to detachably receive the mounting plate of the brace member assembly.

4. The window opening protector assembly of claim 1, wherein the adjustable foot element has a flat bottom surface and is rotatable so that said bottom surface can mate flush with an engaging surface when the foot element engages frictionally with said engaging surface at an angle to the window opening.

5. The window opening protector assembly of claim 1, wherein the cover element is pre-cut to standard window sizes.

6. The window opening protector assembly of claim 1, wherein the cover element is cut to a dimensional size to fit the window opening using a template, the template comprising a gridded pattern marking height and width dimensions for the window opening.

7. The window opening protector assembly of claim 1, wherein the cover element is made of material selected from the group consisting of cardboard, plywood, polystyrene, or plastic.

8. The window opening protector assembly of claim 1, wherein the adjustable pole member has at least one lockable hinge mechanism.

9. The window opening protector assembly of claim 1, wherein the adjustable pole member is a pole having a plurality of sections mated together.

10. The window opening protector assembly of claim 1, wherein the adjustable pole member further comprises:
a plurality of telescoping tubular members;
a first telescoping tubular member having side walls shaped to conformingly mate with a second telescoping tubular member;
said second telescoping tubular member being telescopingly mated with said first telescoping tubular member, said second telescoping tubular member being sized and shaped to conformingly mate with said first telescoping tubular member;
a holding mechanism for fixing said second telescoping tubular member to said first telescoping tubular member within a range of relative positions between said first and second telescoping tubular members so that the length of said pair of telescoping tubular members, when telescoped, can be adjusted to a position within said range and held in such position; and
lock mechanism, for locking said first telescoping tubular member to said second telescoping tubular member in any of said positions within said range.

11. The window opening protector of claim 10, wherein the lock mechanism is a detent on a first telescoping tubular member received in one of a plurality a detent holes formed in a second tubular member within a range of relative positions between said first and second telescoping tubular members, said detent locking said second tubular member in place relative to the first tubular member when in a desired position.

12. A brace assembly to secure a cover element in a window opening, the brace assembly comprising
an adjustable pole member with two ends; a first end to contact the cover element and a second end to contact an engaging surface;
a mounting plate with two sides;
a first coupling side, detachably and rotatably coupled at one end of the adjustable pole member; and
a second engaging side, to detachably contact the cover element and press against the cover element;
an adjustable foot element attached at a second end of the adjustable pole member, to frictionally engage the engaging surface at an angle to the window opening.

13. The brace assembly of claim 12, wherein the adjustable pole member further comprises:
a plurality of telescoping tubular members;
a first telescoping tubular member having side walls shaped to conformingly mate with a second telescoping tubular member;
said second telescoping tubular member being telescopingly mated with said first telescoping tubular member, said second telescoping tubular member being sized and shaped to conformingly mate with said first telescoping tubular member;
holding mechanism for fixing said second telescoping tubular member to said first telescoping tubular member within a range of relative positions between said first and second telescoping tubular members so that the length of said pair of telescoping tubular members, when telescoped, can be adjusted to a position within said range and held in such position; and
a lock mechanism for locking said first telescoping tubular member to said second telescoping tubular member in any of said positions within said range.

14. The brace assembly of claim 13, wherein said lock mechanism is a detent on a first telescoping tubular member received in one of a plurality a detent holes formed in a second tubular member within a range of relative positions between said first and second telescoping tubular members, said detent locking said second tubular member in place relative to the first tubular member when in a desired position.

15. A method of protecting a window opening of a building comprising:
providing a cover element cut to the size of a window opening;
providing a brace assembly, further comprising an adjustable pole member, a rotatably and detachably coupled mounting plate, and an adjustable foot element;
placing the cover element over the window opening;
positioning a first end of the brace assembly with the mounting element against the cover element,
pressing the cover element over the window opening; and
bracing the cover element against the window opening by adjusting the length of the a adjustable pole member of the brace assembly.

16. The method of claim 15, wherein the brace assembly is adjusted by extending the length of the adjustable pole member, wherein in said adjustable pole member has a plurality of sections mated together.

17. The method of claim 15, wherein the brace assembly is adjusted by extending the length of the adjustable pole member, wherein the adjustable pole member has a plurality of telescoping tubular members further comprising the steps:
providing a plurality of interfitting tubular members;
placing a first telescoping tubular member having side walls shaped to conformingly mate with a second telescoping tubular member;
placing a second telescoping tubular member within the first telescoping member, the second member being sized and shaped to conformingly mate with said first telescoping tubular member;
adding additional telescoping tubular members until the desired length is achieved by adjusting the telescoping members, one within the other, until the brace assembly presses the cover member into place in the window opening, and the adjustable foot is engaged with an engaging surface;
fixing said second telescoping tubular member to said first telescoping tubular member within a range of relative positions between said first and second telescoping tubular members so that the length of said pair of telescoping tubular members, when telescoped, can be adjusted to a position within said range and held in such position; and
locking said first telescoping tubular member to said second telescoping tubular member in any of said positions within said range.

18. The method of claim 17, wherein locking said first telescoping tubular member to said second telescoping tubular member in any of said positions within said range is by actuating a detent on a first telescoping tubular member received in one of a plurality a detent holes formed in a second tubular member within a range of relative positions between said first and second telescoping tubular members, said detent locking said second tubular member in place relative to the first tubular member when in a desired position.

19. The method of claim 15, wherein positioning a first end of the brace assembly with the mounting element against the cover element further comprises the step of positioning the mounting plate in a mounting bracket on the cover element.

20. The method of claim 15, wherein the wherein the brace assembly is angularly adjusted by lockable hinge mechanisms along the length of the adjustable pole member.
